(19) United States
(12) Patent Application Publication
(10) Pub. No.: US 2002/0134750 A1
(43) Pub. Date: Sep. 26, 2002

(54) Optical carrier

(75) Inventor: Claes Bertil Blom, Skanninge (SE)

Correspondence Address: LAW OFFICE OF LAWRENCE E LAUBSCHER, JR, 1160 SPA RD, SUITE 2B, ANNAPOLIS, MD, 21403, US

(73) Assignee: Zarlink Semiconductor AB, Jarfalla (SE)

(21) Appl. No.: 10/100,633

(22) Filed: Mar. 15, 2002

(30) Foreign Application Priority Data
Mar. 20, 2001 (GB) 0106888.1

(51) Int. Cl. B29D 11/00; G02B 6/26

(52) U.S. Cl. 216/24; 385/52

(57) ABSTRACT

A method of making an optical device on a carrier plate involves defining on one side of the carrier plate electrical contacts and through-holes for guide pins by a photolithographic process. The components are then mounted on the contacts and the guide pins of are mounted through the through-holes, using the through-holes as guides.

### FIELD OF THE INVENTION

This invention relates to the field of optical fiber communications, and in particular to a method of making an optical carrier for supporting active optical components.

### BACKGROUND OF THE INVENTION

In an optical fiber communications system, electro-optical components comprise optical chips, typically VCSELs (Vertical Cavity Semiconductor Lasers), or PIN diodes in the case of receivers mounted on a support or carrier along with the necessary driver circuits for the electro-optical components. The light is carried away by optical fibers and these of course must be very accurately aligned to the electro-optical components in achieve an acceptable coupling of the light into the fibers.

It is common to use a pair of guide pins protruding from the carrier, which typically forms part of a heat sink. When guide pins are used, however, they commonly not are secured to the carrier to the same level of precision as the fastening structures for the electro-optical chip. Another problem is that the solder structures on the chip often sit on the same side as the active optical area of the chip where the light is emitted or received.

In the case of a transmitting electro-optical chip, the driver circuits have to be mounted very close to the chip, especially at high transmission speeds. The same situation occurs when very fast signals have to be received at very high speed.

Thermal issues also have to addressed in order to effectively dissipate the heat generated by the electro-optical components and driver chips in the case of a transmitter. In the case of a receiver, the heat generated by the transimpedance amplifiers has to be dissipated.

An object of the invention is to address the afore-mentioned problems.

### SUMMARY OF THE INVENTION

Accordingly, the present invention provides a method of making an optical device, comprising providing a carrier plate, defining on one side of said carrier plate electrical contacts and through-holes for guide pins by a photolithographic process, mounting components on said contacts, and mounting said guide pins through said through-holes. Holes or openings through the carrier are formed by etching or like processes to provide a free path for the light between the electro-optical component and the optical fiber. The heat from chips is effectively dissipated and distributed in the carrier.

The invention thus provides a way of accurately aligning all the critical components in one step prior to their mounting. Once the contacts have been formed, the components can be precisely mounted thereon using a solder alignment technique. The guide pins can be precisely aligned using the photolithographically defined guide pins as a guide.

### BRIEF DESCRIPTION OF THE DRAWINGS

The invention will now be described in more detail, by way of example only, with reference to the accompanying drawings, in which;

FIG. 1 is an end view of an optical carrier in accordance with one embodiment of the invention; and

FIG. 2 is a plan view of the carrier coupled to a connector.

### DETAILED DESCRIPTION OF THE PREFERRED EMBODIMENTS

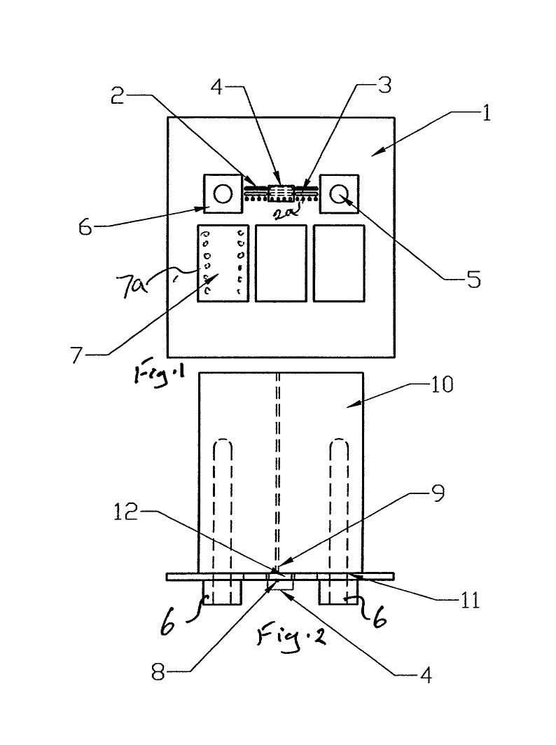

FIG. 1 shows a square carrier 1 of heat conductive material, such as sapphire, having bonded on its backside a pair of pedestal supports 6 and one or more active optical chips 4 consisting, for example, of VCSELs or PIN diodes.

Driver or transimpedance chips 7 are also mounted on the backside of the carrier 1 for connection to the optical chips 4 via solder pads 2, and individual energizing contacts 2a also mounted on the backside of the chip. The optical chips 4 are mounted on the energizing contacts 2a and solder pads 2 using flip-chip bonding techniques, which are known per se to persons skilled in the art.

Guide pins of a type known per se protrude from the pedal supports 6 on the front side of the carrier 1 passing through through-holes 11 formed in the carrier. The guide pins are used to align the ferrule carrying the optic fibers. It is critical that the guide pins be precisely positioned relative to the VCSELs, because alignment of the ferrule with the guide pins ensures that the optic fibers are in turn aligned with the VCSELs or other active components.

Elongate holes openings 3 are formed in the carrier 1 in front of the active components of the chip 4. These openings define voids 12, which may or may not be filled with transparent material.

An optical connector 10 having an optical fiber 9 passing therethrough is mountable on the front side of the carrier 1, with the guide pins 5 mating with complementary bores in the connector 10. The guide pins 5 ensure that the connector 10 is properly located, and hence the optical fiber 9 is accurately aligned with the active components of the chips 4 through openings 3 which may or may not be filled.

In use the light passes from the electro-optical chip 4 and its transmitting or receiving active optical area 8 through the filled or unfilled void 12 to one or more optical fibers 9 mounted in the optical contact 10.

In accordance with the principles of the invention, all the elements critical for alignment, namely the energizing contacts 2a, the solder pads 2, the openings 3, holes 5, and the contacts 7a for the driver or transimpedance chips 7 are formed by photolithography. A photo resist material is first deposited on the carrier 1 and then exposed to define the above components. After removal of the exposed material, the guide pin holes 5 and openings 3 are formed by etching. Next, the solder pads 2, energizing contacts 2a, and driver chip contacts 7a can be deposited on the sapphire substrate through the photolithographic mask.

Finally, the pedestal supports 6 are bonded to the back side of the carrier 1 in alignment with the through-holes formed by etching. The guide pins 5 are then inserted so that they protrude from the front side of the carrier 1 to receipt of the optical connector 10.

By using a common lithographic process on one side of the substrate, all the critical components can be very accurately aligned relative to each other. The driver chips 7, when mounted, will then automatically be aligned with the optical components 4. The connections can be effected using a solder alignment process to ensure that the components are accurately located relative to the photolithographically produced contacts. Similarly, the fact that the holes 11 for the guide pins 11 ensures that the guide pins, when inserted, will be accurately positioned relative to the optical chips 4.

It will be seen that the invention therefore provides a carrier wherein the guide pin holes, the solder pads for the chip and the wirebond or flip chip pads for mounting of the driver or transimpedance amplifier chip can all be defined by photolithography. Any suitable photolithographic technique known to persons skilled in the art can be employed.

1. A method of making an optical device, comprising providing a carrier plate, defining on one side of said carrier plate electrical contacts and through-holes for guide pins by a photolithographic process, mounting components on said contacts, and mounting said guide pins through said through-holes.

2. A method as claimed in claim 1, wherein a light transmissive opening is also defined on said plate by said photolithographic process.

3. A method as claimed in claim 1, wherein said through-holes are formed by etching after they have been defined by said photolithographic process.

4. A method as claimed in claim 1, further comprising bonding supporting pedestals for said guide pins said one side of said plate in alignment with said through-holes formed by said lithographic process.

5. A method as claimed in claim 1, wherein said components are flip-chip bonded to said contacts.

6. A method as claimed in claim 1, wherein said carrier plate is made of sapphire.

7. A method as claimed in claim 1, wherein said electrical contacts include solder pads and energizing contacts for active optical components flip-chip bonded thereto.

8. A method as claimed in claim 7, wherein said solder pads and energizing contacts are arranged in parallel lines between said through-holes.

9. A method as claimed in claim 7, wherein said components are mounted on said electrical contacts and energizing contacts using a solder alignment technique.
